(19) United States
(12) Patent Application Publication
(10) Pub. No.: US 2026/0118543 A1
(43) Pub. Date: Apr. 30, 2026

(54) UNMANNED AERIAL VEHICLE ARRAY-BASED AIRBORNE MULTI-COMPONENT ELECTRIC AND MAGNETIC FIELD COOPERATIVE DETECTION SYSTEM AND DETECTION METHOD

(71) Applicant: Aerospace Information Research Institute, Chinese Academy of Sciences, Beijing (CN)

(72) Inventors: LiHua LIU, Beijing (CN); GuangYou FANG, Beijing (CN); XiaoJun LIU, Beijing (CN); JiangJie HUANG, Beijing (CN); JianKai LI, Beijing (CN); Shun WANG, Beijing (CN); ShiChu YAN, Beijing (CN); XianZhe YIN, Beijing (CN)

(21) Appl. No.: 19/427,829

(22) Filed: Dec. 19, 2025

(30) Foreign Application Priority Data
Oct. 24, 2024 (CN) 202411489866.3

(51) Int. Cl. G01V 3/165; B64U 10/60; B64U 20/80; B64U 101/35

(52) U.S. Cl. CPC G01V 3/165; B64U 10/60; B64U 20/80; B64U 2101/35

(57) ABSTRACT

An unmanned aerial vehicle (UAV) array-type airborne multi-component electric and magnetic field cooperative detection system and a detection method are provided. The detection system includes a UAV array, a transmitting unit, a plurality of receiving units and a ground support unit; wherein the UAV array includes a primary UAV and a plurality of follower UAVs; the transmitting unit is configured to transmit a primary electromagnetic field pulse; the transmitting unit includes a loop source transmitting device; the loop source transmitting device includes a current transmitter, a transmitting coil and a compensation coil; the plurality of receiving units are respectively mounted under the primary UAV and the follower UAVs, and are configured to collect electromagnetic data after a primary electromagnetic field pulse acts on a region to be measured, wherein the electromagnetic data includes a horizontal component electric field signal and a three-component magnetic field signal; each receiving unit includes a capacitive electric field sensor, a three-component coil magnetic field sensor, and an electromagnetic data receiver; and the ground support unit is configured to control the collection of the horizontal component electric field signal and the three-component magnetic field signal, and perform electromagnetic data processing to obtain the underground space electrical information about the detection region.

### BACKGROUND

### Technical Field

The present disclosure relates to the technical field of electromagnetic detection, and in particular, to an unmanned aerial vehicle (UAV) array-based airborne multi-component electric and magnetic field cooperative detection system and a detection method.

### Description of the Related Art

Transient electromagnetic method (TEM) is a geophysical method to obtain the resistivity distribution of underground media by analyzing and studying the response characteristics of secondary field generated by induced eddy current in the underground media excited by the external field source. According to the basic principle, the ungrounded return wire or ground wire source emits the primary pulse magnetic field into the ground. During the intermittent period of the primary pulse magnetic field, the coil or ground electrode is used to detect the secondary induced eddy current field induced in the underground media. Geoelectric characteristics of different depths can be obtained by measuring the variation of the secondary field with time in different time periods after power-off. According to different instrument platforms, the induction electromagnetic method can be divided into three modes: full airborne mode, semi

airborne mode and ground detection mode. Among them, the full-aviation transient electromagnetic method adopts helicopters or unmanned aerial vehicles (UAVs) equipped with integrated electromagnetic field transceivers, and uses the loop source to emit the primary pulse magnetic field to excite the underground abnormal electrical body to generate the secondary electromagnetic field response. This method is particularly sensitive to the low-resistivity targets, and is mostly used for the detection of metal minerals, groundwater and other targets.

At present, the airborne electromagnetic detection technology has been developed and applied more maturely, this system makes use of UAVs or helicopters to place the entire in the air to carry out detection, which has the advantages of flexibility, low manpower cost and high detection efficiency. However, the traditional airborne electromagnetic detection technology can only detect a: single component of magnetic field signal, and can not achieve airborne electric field measurement. Thus, the ground electric field measurement system can not be extended to the UAV platform, and still need manpower to deploy ground stations for working. Until recent years, the hardware technology of electric field sensors has made breakthrough progress, which makes stable measurement of electric field component in the air possible. On the other hand, the existing airborne electromagnetic detection system is composed of transmitting sources and receiving sensors mounted on the single flight platform. With the rapid development of hardware and software technology, the unmanned operation, miniaturization, integration and arraying of geophysical detection system has become an inevitable trend in the future. However, due to the fixed relative position of transmitting and receiving in the traditional single-flight operation mode, the limited amount of anomalous electromagnetic response information, generated by the excitation of underground electrical media by the transmitting source, is captured by the sensor. For complex three-dimensional underground space detection, it is faced with a severe problem of multiple solutions.

### BRIEF SUMMARY

Therefore, in order to at least partially solve at least one of the above-mentioned technical problems, the present disclosure provides a UAV array-type airborne multi-component electric and magnetic field cooperative detection system and a detection method, aiming at improving the detection accuracy of a three-dimensional target body in a complex underground space by combining an unmanned aerial vehicle (UAV) array platform with an electric and magnetic field multi-parameter cooperative detection system to simultaneously acquire multi-view angle and multi-parameter electromagnetic response information about underground electrical media.

In order to achieve the above-mentioned object, the technical solution of the present disclosure is as follows.

According to an embodiment of one aspect of the present disclosure, an unmanned aerial vehicle (UAV) array-based airborne multi-component electric and magnetic field cooperative detection system includes a UAV array, a transmitting unit, a plurality of receiving units and a ground support unit; wherein the UAV array includes a primary UAV and a plurality of follower UAVs; the transmitting unit is mounted under the primary UAV and is configured to transmit a primary electromagnetic field pulse; the transmitting unit includes a loop source transmitting device; the loop source transmitting device includes a current transmitter, a transmitting coil and a compensation coil; the plurality of receiving units are respectively mounted under the primary UAV and the follower UAVs, and are configured to collect electromagnetic data after a primary electromagnetic field pulse acts on a region to be measured, wherein the electromagnetic data includes a horizontal component electric field signal and a three-component magnetic field signal; each receiving unit includes a capacitive electric field sensor, a three-component coil magnetic field sensor, and an electromagnetic data receiver; and the ground support unit is configured to control the collection of the horizontal component electric field signal and the three-component magnetic field signal, and perform electromagnetic data processing to obtain the underground space electrical information about the detection region.

According to an embodiment of the present disclosure, the capacitive electric field sensor includes an x-component electric field sensor and a y-component electric field sensor. The x-component electric field sensor is configured to point parallel to a travel direction of a survey line for measuring an x-component electric field. The y-component electric field sensor is configured to point perpendicular to the travel direction of the survey line for measuring a y-component electric field.

According to an embodiment of the present disclosure, the capacitive electric field sensor uses a non-contact measurement principle to convert an unknown electric field to be measured into a voltage at both ends of a capacitor; the capacitive electric field sensor is arranged at front and rear ends of a connecting framework in the traveling direction of the survey line; the capacitive electric field sensor includes an upper polar plate, a lower polar plate, a measurement circuit board and an insulating upright post; the upper polar plate and the lower polar plate are arranged in parallel to form a parallel plate capacitor, and the material, the area and the thickness of the upper polar plate and the lower polar plate are all the same; two input ends of the measurement circuit board are respectively connected to the upper polar plate and the lower polar plate; the measurement circuit board includes a sampling capacitor; the insulating upright post is configured to connect and fix the upper polar plate, the lower polar plate and the measurement circuit board; the capacitive electric field sensor is placed in an electric field space, and charges generated on the surfaces of the upper polar plate and the lower polar plate will form a voltage at both ends of the sampling capacitor; and electric field data is obtained by measuring the voltage at both ends of the sampling capacitor.

According to an embodiment of the present disclosure, a three-component coil magnetic field sensor includes an x-component magnetic field sensor, a y-component magnetic field sensor and a z-component magnetic field sensor. The x-component magnetic field sensor is configured in a semi-circle shape, with the normal to the plane of the sensor being directed in an x-direction, for measuring an x-component magnetic field; the y-component magnetic field sensor is configured in a semi-circle shape, with the normal to the plane of the sensor being directed in a y-direction, for measuring a y-component magnetic field; and the z-component magnetic field sensor is configured in a circular shape, with the normal to the plane of the sensor being directed in a z-direction, for measuring a z-component magnetic field.

According to an embodiment of the present disclosure, the transmitting coil, the compensation coil and the z-component magnetic field sensor are arranged in the same plane; and the radius ratio of the transmitting coil and the compensation coil is equal to the ratio of the turns of the transmitting coil and the compensation coil.

According to an embodiment of the present disclosure, the electromagnetic data receiver includes a signal conditioning module, a signal acquisition module, a storage module and a transmission module. The signal conditioning module is configured to perform filtering and amplification on the received horizontal component electric field signal and three-component magnetic field signal. The signal collection module includes an analogue-to-digital converter circuit and is configured to perform data sampling on a signal conditioned by the signal conditioning module. The storage module is configured to store the multi-component electric field data and magnetic field data sampled by the signal collection module. The transmission module is configured to transmit the collected multi-component electric field data and magnetic field data to the support unit.

The ground support unit includes a control device, a monitoring device and a data processing device. The control device is configured to send a work control instruction by the cooperative detection system; the monitoring device is configured to monitor a system parameter state, multi-component electric field data, magnetic field data, and cooperative detection system location information of the cooperative detection system in real time; and the data processing device is configured for electromagnetic data processing to obtain the underground space electrical information about the detection region.

According to an embodiment of the present disclosure, the cooperative detection system further includes a positioning device, a radar altimeter, and a power supply device. The positioning device is configured to provide real-time positioning the UAV array and obtain longitude and latitude information about each UAV in the UAV array; the radar altimeter is configured to measure a flight altitude of the UAV array; and the power supply device is configured to supply power to the cooperative detection system.

According to another aspect of the present disclosure, there is provided a detection method based on the cooperative detection system of any of the above, including: S1, assembling and debugging a cooperative detection system; S2, setting up system parameters of the detection system and flight parameters of an unmanned aerial vehicle (UAV) array according to a field situation and user detection requirements; S3, implementing the excitation of a primary electromagnetic pulse signal by the central primary field compensation technology according to a received control instruction; S4, collecting a horizontal component electric field signal and a three-component magnetic field signal data; and S5, preprocessing the acquired data of the horizontal component electric field signal and the three-component magnetic field signal, and obtaining underground space electrical information of a detection region by means of a joint inversion method of the electric and magnetic field data.

According to an embodiment of the present disclosure, the system parameters of the detection system include a transmitting current amplitude, a transmitting current shape, a transmitting current frequency of a current transmitter and a sampling rate of an electromagnetic data receiver; the flight parameters of the UAV array include a UAV array formation mode, a flight height, a flight speed and a flight route.

According to an embodiment of the present disclosure, the obtaining underground space electrical information of a detection region by means of a joint inversion method of the electric and magnetic field data includes: S51, setting an initial resistivity model and model parameters; S52, obtaining magnetic field response errors and electric field response errors by calculating errors between the magnetic field response and the electric field response of the initial resistivity model and the detected magnetic field response and electric field response by using the forward modeling of magnetic and electric field response; S53, constructing the Jacobian matrix of magnetic field and electric field data inversion by using the resistivity model, and calculating a model update quantity of magnetic field data inversion and a model update quantity of electric field data inversion by using the magnetic field response errors and the electric field response errors; S54, obtaining the updated resistivity model by adding the model update quantity and the model parameters; S55, judging whether a fitting error of the forward-modeling electric and magnetic field response data of the updated resistivity model is less than a set threshold value, and successively determining whether to perform iteration; and S56, ending the iteration when the fitting error is less than the set threshold value, and adding one to the number of iterations when the fitting error is greater than the set threshold value, and proceeding to the step S53; at this moment, the electric field inversion updated resistivity model is obtained by calculating the model parameters obtained from the magnetic field inversion in the last iteration, and the magnetic field inversion updated resistivity model is obtained by calculating the model parameters obtained from the electric field inversion in the last iteration, until the fitting error is less than the set threshold value to end the iteration.

### BRIEF DESCRIPTION OF THE SEVERAL VIEWS OF THE DRAWINGS

The foregoing and other objects, features and advantages of the disclosure will be apparent from the following description of embodiments of the disclosure with reference to the accompanying drawings, in which:

FIG. 1 schematically illustrates a schematic diagram of an operational scenario of an unmanned aerial vehicle (UAV) array-type airborne multi-component electric and magnetic field cooperative detection system according to an embodiment of the present disclosure.

FIG. 2a is a structurally schematic view of primary UAV air transmitting and receiving units of a UAV array-type airborne multi-component electric and magnetic field cooperative detection system according to an embodiment of the present disclosure.

FIG. 2b is a structurally schematic view of a follower air receiving unit of the UAV array-type airborne multi-component electric and magnetic field cooperative detection system according to an embodiment of the present disclosure.

FIG. 3 schematically illustrates a central primary field compensation technique schematic diagram of the UAV array-type airborne multi-component electric and magnetic field cooperative detection system according to an embodiment of the present disclosure.

FIG. 4 schematically shows a schematic diagram of an internal structure of a capacitive electric field sensor of the UAV array-type airborne multi-component electric and magnetic field cooperative detection system according to an embodiment of the present disclosure.

FIG. 5 schematically illustrates a flowchart of a detection method based on the UAV array-type airborne multi-component electric and magnetic field cooperative detection system, according to an embodiment of the present disclosure.

FIG. 6 schematically illustrates an electromagnetic response diagram after processing by the central primary field compensation technique according to an embodiment of the present disclosure.

FIG. 7a schematically shows a flow chart of a method of joint inversion of electric and magnetic field data according to an embodiment of the present disclosure.

FIG. 7b schematically illustrates a flow architecture diagram of a method for joint inversion of electric and magnetic field data according to an embodiment of the present disclosure.

### DETAILED DESCRIPTION

The present disclosure provides an unmanned aerial vehicle (UAV) array-based airborne multi-component electric and magnetic field cooperative detection system and a detection method, which achieves the simultaneous reception of multi-directional and multi-component electric and magnetic field data in the air, solves the problems of a single electromagnetic response acquisition parameter and limited information quantity in a single vehicle detection mode of the traditional airborne electromagnetic detection technology, and improves the detection accuracy in the field of underground space detection.

The purpose, aspects, and advantages of the present disclosure will become more apparent from the detailed description set forth below when taken in conjunction with the specific embodiments and with reference to the drawings.

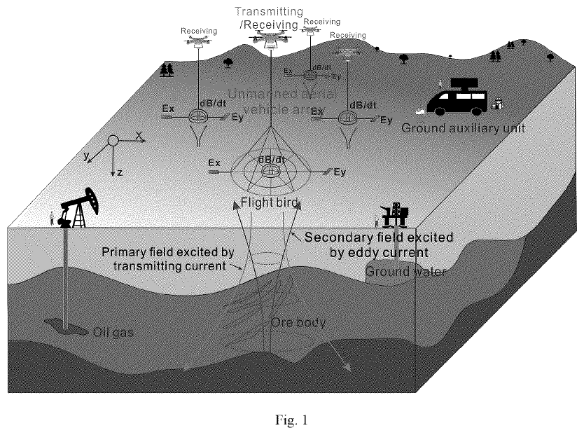

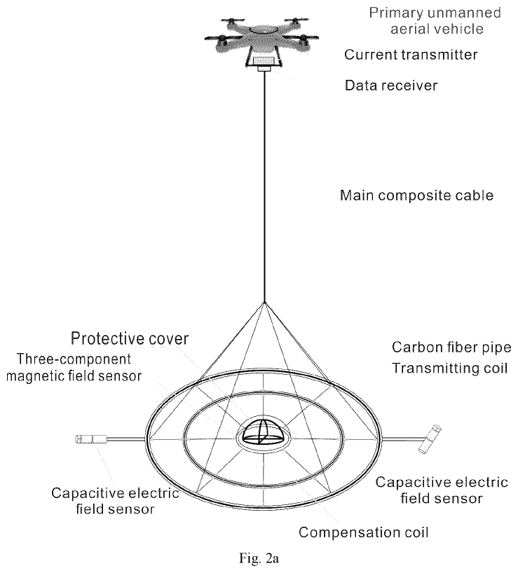

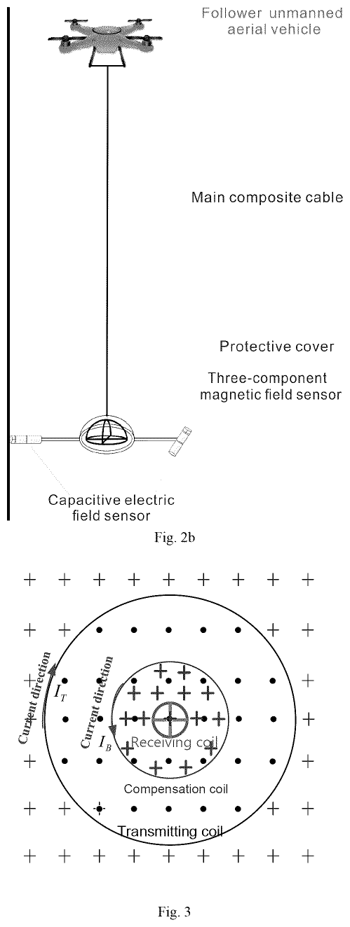

In an embodiment of the present disclosure, a UAV array-type airborne multi-component electric and magnetic field cooperative detection system is provided. As shown in conjunction with FIGS. 1, 2a and 2b, the cooperative detection system includes a UAV array, a transmitting unit, a plurality of receiving units and a ground support unit;
wherein the UAV array includes a primary UAV and a plurality of follower UAVs;
the transmitting unit is mounted under the primary UAV and is configured to transmit a primary electromagnetic field pulse; the transmitting unit includes a loop source transmitting device; the loop source transmitting device includes a current transmitter, a transmitting coil and a compensation coil;
the plurality of receiving units are respectively mounted under the primary UAV and the follower UAVs, and are configured to collect electromagnetic data after a primary electromagnetic field pulse acts on a region to be measured, wherein the electromagnetic data includes a horizontal component electric field signal and a three-component magnetic field signal; each receiving unit includes a capacitive electric field sensor, a three-component coil magnetic field sensor, and an electromagnetic data receiver; and
the ground support unit is configured to control the collection of the horizontal component electric field signal and the three-component magnetic field signal, and perform electromagnetic data processing to obtain the underground space electrical information about the detection region.

The above-mentioned primary UAV platform is mounted with a transmitting unit and a receiving unit at the same time. The number of the above-mentioned follower UAV platforms is 3-5, and only the receiving unit is mounted, forming a different transceiving distance from the primary UAV platform. The above-mentioned compensation coil is provided between the transmitting coil and the three-component coil magnetic field sensor, and the currents passing through the above-mentioned compensation coil and the above-mentioned transmitting coil are of the same magnitude and in opposite directions, so as to eliminate electromagnetic field interference of the above-mentioned transmitting coil on the above-mentioned three-component coil magnetic field sensor. The above-mentioned three-component coil magnetic field sensor is used for acquiring magnetic field data of x, y and z components, and the above-mentioned capacitive electric field sensor is used for acquiring electric field data of horizontal x and y components.

According to an embodiment of the present disclosure, the platform of primary UAV and the follower UAVs are the same type of UAV. The nacelle below the primary UAV platform includes a transmitting unit, a receiving unit and a connecting device at the same time. The nacelle below the follower UAV platform includes only the receiving unit and the connecting device, and keeps synchronization with the UAV platform and flies in the same direction. The primary UAV platform and the follower UAV platform can be located at different heights, and the relative distance between each other ranges from 30 m to 150 m, so as to ensure detection accuracy. The above-mentioned connecting device may include, for example, a signal cable, a rope composite cable and a connecting framework. The above-mentioned connecting device is used for realizing the fixing or connection between a primary UAV, a follower UAV and a corresponding transmitting unit, receiving unit, and between the transmitting unit and the receiving unit.

According to an embodiment of the present disclosure, the above-mentioned transmitting coil, the above-mentioned compensation coil and the z-component coil in the above-mentioned three-component coil magnetic field sensor are all provided in the same horizontal plane and are concentric, and are connected and fixed via the rope composite cable and suspended below the UAV. The transmitting coil and the compensation coil each have a circular shape. In addition, the transmitting coil and the compensation coil may, for example, both be bundled in a circular tube made of a carbon fiber material in order to maintain the shape of the coil and to ensure the electrification safety.

According to an embodiment of the present disclosure, the above-mentioned current transmitter can generate continuous current waveforms with different amplitudes, different frequencies and different shapes according to user requirements, and load same into the transmitting coil to form an air loop source to radiate the electromagnetic field outwards. In addition, the current transmitters are individually powered by the UAV.

According to an embodiment of the present disclosure, the capacitive electric field sensor includes an x-component electric field sensor and a y-component electric field sensor. Herein, the x-component electric field sensor and the y-component electric field sensor respectively point in the x- and y-directions and are used for measuring the x-component and y-component electric fields in the air. The x-component electric field sensor and the y-component electric field sensor have the same performance parameters, and are connected at the front and rear ends in the traveling direction of the transmitting coil via the connecting skeleton.

According to an embodiment of the present disclosure, the above-mentioned three-component coil magnetic field sensor includes an x-component magnetic field sensor, a y-component magnetic field sensor and a z-component magnetic field sensor. The three-component coil magnetic field sensors described above are used to measure the x-component, y-component, and z-component magnetic fields, respectively, and are placed two by two orthogonally within a hemispherical protective cover.

According to an embodiment of the present disclosure, the electromagnetic data receiver includes a signal conditioning module, a signal collection module, a storage module and a transmission module. The signal conditioning module is configured to filter and amplify the received multi-component electric and magnetic field data. The signal collection module is an analog-to-digital converter circuit, which is configured for data sampling of the conditioned signal. The storage module is configured to store the collected multi-component electric and magnetic field data. The transmission module is configured to remotely transmit the collected multi-component electric and magnetic field data to the ground support unit.

According to an embodiment of the present disclosure, the above-mentioned UAV airborne multi-component electric and magnetic field cooperative detection system further includes a positioning device configured to position the UAV array system real-time and obtain longitude and latitude information about the above-mentioned UAV array system; a radar altimeter configured to measure the flight height of the UAV array system; and a power supply device configured for supplying power to the cooperative detection system, for example, for supplying power to the UAV array system and the transmitting unit. The above-mentioned ground support unit includes a control device for sending work orders, such as start, pause, continuation and termination, to the system; a monitoring device for real-time monitoring of system status (such as the parameter status of detection system), electric and magnetic field data, and information such as the system position and height; and a data processing device configured to process electromagnetic data to obtain the underground space electrical information about the detection region. The above-mentioned system parameters of the detection system may include, for example, a transmitting current amplitude, a transmitting current shape, a transmitting current frequency of a current transmitter and a sampling rate of an electromagnetic data receiver; the flight parameters of the UAV array include a UAV array formation mode, a flight height, a flight speed and a flight route.

In another aspect of the embodiments of the present disclosure, there is provided a detection method based on the above-mentioned UAV array-type airborne multi-component electric and magnetic field cooperative detection system, as shown in FIG. 5, the above-mentioned detection method including:
S1, assembling and debugging a cooperative detection system;
S2, setting up system parameters of the detection system and flight parameters of an unmanned aerial vehicle (UAV) array according to a field situation and user detection requirements;
S3, implementing the excitation of a primary electromagnetic pulse signal by the central primary field compensation technology according to a received control instruction;
S4, collecting a horizontal component electric field signal and a three-component magnetic field signal data; and
S5, preprocessing the acquired data of the horizontal component electric field signal and the three-component magnetic field signal, and obtaining underground space electrical information of a detection region by means of a joint inversion method of the electric and magnetic field data.

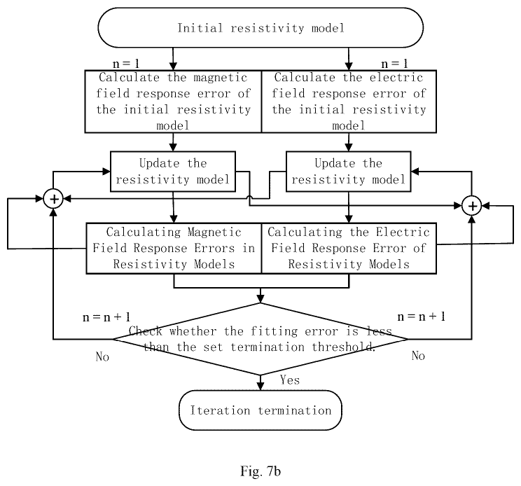

According to the common embodiment, in conjunction with FIGS. 5, 7a and 7b, the obtaining underground space electrical information of a detection region by means of a joint inversion method of the electric and magnetic field data includes:
S51, setting an initial resistivity model and model parameters;
S52, obtaining magnetic field response errors and electric field response errors by calculating errors between the magnetic field response and the electric field response of the initial resistivity model and the detected magnetic field response and electric field response by using the forward models of magnetic and electric field response;
S53, constructing the Jacobian matrix of magnetic field and electric field data inversion by using the resistivity model, and calculating a model update quantity of magnetic field data inversion and a model update quantity of electric field data inversion by using the magnetic field response errors and the electric field response errors;
S54, obtaining the updated resistivity model by adding the model update quantity and the model parameters;
S55, judging whether a fitting error of the forward-modeling electric and magnetic field response data of the updated resistivity model is less than a set threshold value, and successively determining whether to perform iteration; and
S56, ending the iteration when the fitting error is less than the set threshold value, and adding one to the number of iterations when the fitting error is greater than the set threshold value, and proceeding to the step S53; at this moment, the electric field inversion updated resistivity model is obtained by calculating the model parameters obtained from the magnetic field inversion in the last iteration, and the magnetic field inversion updated resistivity model is obtained by calculating the model parameters obtained from the electric field inversion in the last iteration, until the fitting error is less than the set threshold value to end the iteration.

According to an embodiment of the present disclosure, as shown in conjunction with FIGS. 7a and 7b, in step S56, it is determined whether the forward electric and magnetic field data fitting error of the updated resistivity model is less than a set threshold. If yes, the algorithm terminates; no; 1 is added to the number of iterations n, and it proceeds to the step S53. At this moment, the electric field inversion updated resistivity model is obtained by calculating the model parameters obtained from the magnetic field inversion in the last iteration, and the magnetic field inversion updated resistivity model is obtained by calculating the model parameters obtained from the electric field inversion in the last iteration. The steps S54 and S55 are performed until the iteration termination condition is satisfied.

More specifically, the airborne electromagnetic detection system equipment is assembled and debugged, and the flight safety test of UAV array is carried out to ensure the flight safety of the above-mentioned UAV airborne multi-component electric and magnetic field cooperative detection system when working. The system parameters and flight parameters of the above-mentioned multi-component electric and magnetic field cooperative detection system for the airborne UAV are set according to the field situation and the detection requirements of a user. The above-mentioned system parameters may include, for example, a transmitting current amplitude, a transmitting current shape, a transmitting current frequency of the current transmitter and a sampling rate of the receiving unit. The above-mentioned flight parameters may include, for example, a UAV array formation form, a flight height, a flight speed and a flight route. The system starts to work according to the above-mentioned set parameters. When the system starts to work, the nacelle below the primary UAV sends a pulse electromagnetic field to the loop source transmitting device. The primary UAV and the follower UAVs receiving unit cooperate to continuously collect data of a horizontal component electric field and a three-component magnetic field. The above-mentioned acquired multi-directional detected horizontal component electric field and three-component magnetic field data are preprocessed to obtain underground space electrical information about the detection region by means of the joint inversion method of the electric and magnetic field data.

According to an embodiment of the present disclosure, with the aid of the UAV array system and the capacitive electric field sensor, it is very convenient to measure multi-directional and multi-component electric field data of an grounded electric source transient electromagnetic system in the air. By setting the compensation coil in the transmitting coil, the electromagnetic interference of the transmitting coil to the magnetic field sensor is reduced, resulting in the pure multi-directional and multi-component magnetic field data, and making the electrical information of underground space obtained by analysis more accurate. With the UAV array acquisition mode, multi-azimuth angle, multi-component electric and magnetic field data can be acquired simultaneously in one air operation. Combined with the multi-directional and multi-component electric and magnetic field data joint inversion method, the multi-solution of single electric field parameter inversion can be effectively reduced, and the system detection information obtained by fusion is more comprehensive and accurate.

According to an embodiment of the present disclosure, as shown in FIG. 1, the UAV array-type airborne multi-component electric and magnetic field cooperative detection system of the embodiment of the present disclosure includes a UAV array, a transmitting unit, a receiving unit and a ground support unit, and has the capability of acquiring horizontal component electric fields (E_{X} and E_{Y}) and three-component magnetic field signals (dB_{X}/dt, dB_{Y}/dt and dB_{Z}/dt directions) in multiple directions at the same time, and can achieve high-precision detection of underground resistivity. Specifically, the UAV array-type airborne multi-component electric and magnetic field cooperative detection system radiates electromagnetic field to the outside by passing pulse current to the airborne loop source, and causes the underground structure to generate induced eddy current. The electric and magnetic field signals generated by the induced eddy current can be acquired from multiple receiving units suspended on the UAV array from multiple directions. Finally, the resistivity information of the underground space can be acquired by analyzing and processing the received electric and magnetic field signal data.

According to an embodiment of the present disclosure, as shown in FIGS. 2a and 2b, the UAVs of the primary UAV and the follower UAVs are flight platforms of the system, for carrying the airborne loop source transmitting device and receiving device, and enabling the detection system to perform air flight detection according to a pre-planned detection path. The UAVs can be remotely controlled by a worker, and the specific structure and performance parameters thereof are not limited herein. As shown in FIG. 2a, the air loop source subsystem of the primary UAV is composed of a transmitting coil, a compensation coil, a three-component magnetic field sensor, a horizontal component electric field sensor, a current transmitter and a data receiver. The current transmitter and the data receiver are integrated in the lower part of the UAV and are independently powered by the UAV. The transmitting coil, the compensation coil, the three-component magnetic field sensor and the electric field sensor are connected and suspended under the UAV by the main cable. FIG. 2b shows the receiving subsystem from the UAV, which only includes a three-component magnetic field sensor, a horizontal component electric field sensor and a data receiver, and does not include the transmitting source. The data receiver is integrated in the lower part of the UAV, and is powered by the UAV alone. The three-component magnetic field sensor and the horizontal component electric field sensor are connected by the main cable and suspended below the UAV.

According to an embodiment of the present disclosure, the above-described current transmitter can generate current pulse waveforms of different amplitudes, different frequencies, and different shapes according to the user's requirements, and load the same into the transmitting coil and the compensation coil. The above-mentioned data receiver is a multi-channel sampling receiver, and multi-channel synchronous acquisition and storage can be performed on electric and magnetic field response data according to a set sampling rate.

According to an embodiment of the present disclosure, as shown in FIG. 2a, the transmitting coil and the compensation coil carried by the primary UAV can be wound by multiple turns of copper wire, the winding directions of the two are opposite, and the ratio of the number of turns of the transmitting coil and the compensation coil is equal to the ratio of the radius of the transmitting coil and the compensation coil. Both the transmitting coil and the compensation coil are bundled in a circular glass fiber tube, with the compensation coil inside the transmitting coil and secured between them by a cable connection.

According to an embodiment of the present disclosure, three-component magnetic field data may be acquired by a three-component coil magnetic field sensor at the center of the transmitting coil. The compensation coil between the transmitting coil and the coil magnetic field sensor can reduce the electromagnetic interference of the transmitting coil to the coil magnetic field sensor, thus making the electrical information of the underground space more accurate. In addition, the three-component coil magnetic field sensor is installed in the hemispherical protective cover, and the compensation coil and the transmitting coil are indirectly connected by the composite cable, so that the direct connection can avoid the forced jounce of the sensor device.

According to an embodiment of the present disclosure, the electric field sensor includes an x-component electric field sensor and a y-component electric field sensor. The x-component electric field sensor and the y-component electric field sensor are directed in the x- and y-directions, respectively, for measuring the x-component and y-component electric fields. The capacitive electric field sensor uses the principle of non-contact measurement, and can measure the electric field component in the air very conveniently without grounding. The performance parameters of all the electric field sensors are the same, and are arranged at the both ends of the transmitting coil via a connecting skeleton. Each electric field sensor is 0.3-0.5 m away from the edge of the transmitting coil.

According to the embodiment of the present disclosure, as shown in FIG. 3, the compensation coil is provided inside the transmitting coil, and the coils of the transmitting coil and the compensation coil are wound in such a manner that the direction I_{T} of the current flowing through the transmitting coil is opposite to the direction I_{B} of the current flowing through the compensation coil. Primary magnetic fields with equal amplitudes and opposite directions are respectively generated in the region of the central receiving coil, so as to better cancel the strong primary field in the secondary electromagnetic field signal received by the three-component magnetic sensor, so as to realize the weak coupling between the transceiving coils, acquire a pure secondary field signal, and reduce the electromagnetic field interference of the transmitting device to the receiving device.

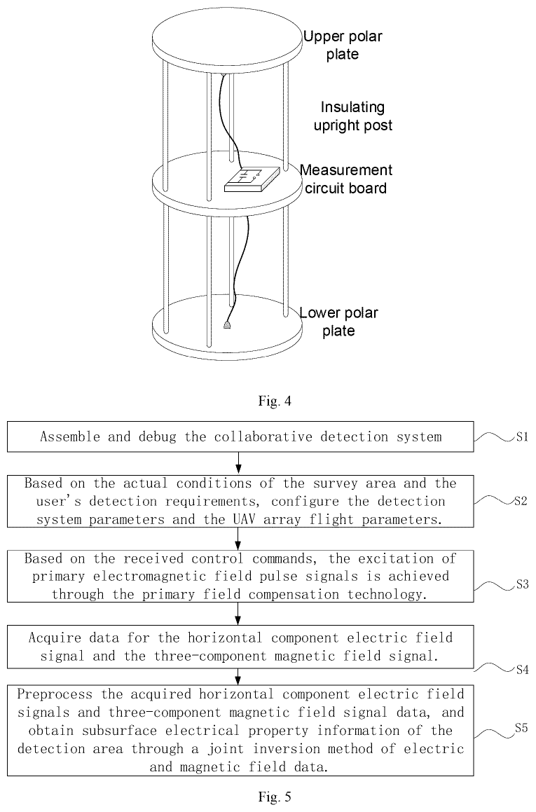

According to an embodiment of the present disclosure, as shown in FIG. 4, the internal structure of the capacitive electric field sensor (which may be simply referred to as a capacitor or a plate capacitor) includes upper and lower symmetrical polar plates, a measurement circuit, and an insulating upright post. The upper and lower polar plates are two copper plates with the same area and thickness, and constitute a parallel plate capacitor. The measurement circuit is used for converting the measurement of the unknown electric field into the measurement of the voltage at both ends of the known capacitor. The insulating upright posts are used to connect the upper and lower polar plates to the measurement circuit board. The measuring principle of capacitive electric field sensor is as follows. The sensor is put into the electric field space, the amount of charge Q on the surface of the plate is proportional to the electric field E between the two polar plates, satisfying Q=C₁EH, where C₁ is the capacitance of the parallel plate capacitor and H is the relative height between the two plates. A wire is used to connect the upper and lower polar plates and the measurement circuit board, wherein the core element of the measurement circuit board is a sampling capacitor C₂, and the charge on the parallel polar plates will form a slight power supply voltage Uₑ=Q/C₂ across the sampling capacitor. Therefore, the electric field E=C₂Uₑ/C₁H between the polar plates can be obtained by measuring the voltage across the sample capacitor. The common mode noise can be suppressed and the sensitivity of the sensor can be improved by using the differential input circuit when measuring the voltage of the sampling capacitor.

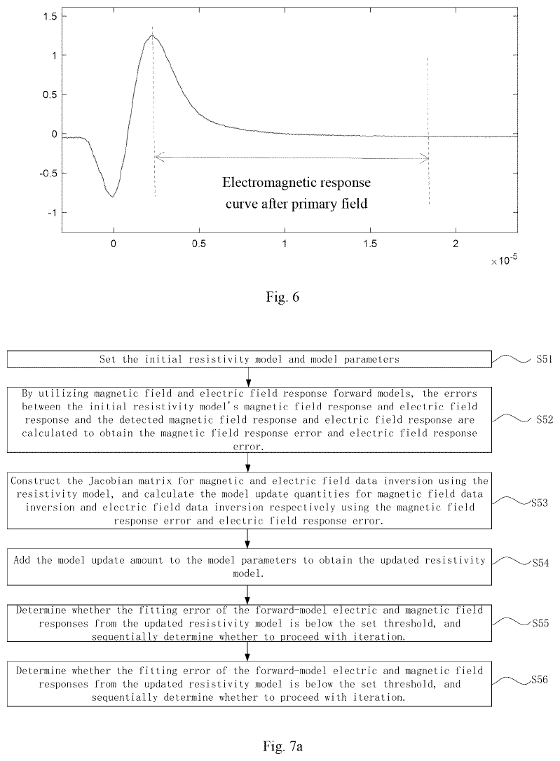

According to an embodiment of the present disclosure, as shown in FIG. 6, after the primary magnetic field compensation, a pure secondary magnetic field reception signal of the underground object can be obtained, which is advantageous in reducing the dynamic range of the receiving unit and improving the quality of the early electromagnetic response signal. Furthermore, the receiving device can obtain relatively pure electromagnetic data, and relatively clear underground target electrical detection images can be obtained by processing the electromagnetic data.

Now, embodiments of the present disclosure have been described in detail with reference to the accompanying drawings. It should be noted that implementations not shown or described in the drawings or the text of the description are forms well known to those of ordinary skill in the art and have not been described in detail. Furthermore, the definitions of the various elements and methods described above are not limited to the particular structures, shapes, or manners set forth in the embodiments, as such may be modified or substituted simply by one of ordinary skill in the art.

Based on the above-mentioned description, a person skilled in the art should clearly recognize the UAV array-type airborne multi-component electric and magnetic field cooperative detection system and the detection method disclosed in the present disclosure.

In summary, the present disclosure provides an unmanned aerial vehicle (UAV) array-type airborne multi-component electric and magnetic field cooperative detection system and a detection method, which uses a light and small-sized UAV as a flight carrying platform, and has the advantages of low flight cost, flexibility and high safety. The present invention breaks through the traditional single aircraft mode of operation, using the UAV array formation detection mode, to achieve multi-azimuth and multi-channel electromagnetic response signal collection. The electromagnetic response characteristics of the rich underground electrical medium are obtained to reduce the inversion multi-solution. In addition, the present invention breaks through the traditional single airborne magnetic field detection, and has invented a method for simultaneous detection of airborne electric and magnetic field, which greatly improves the identification ability of underground detection targets and the detection accuracy of the system by means of cooperative detection of electric and magnetic field.

It should be noted that, in this context, the presence of “a” or “an” element is not limited to a single one of the element, but may include one or more of the elements, unless specifically stated otherwise.

Moreover, in this document, unless otherwise specified, the terms “first,” “second,” and other such ordinals are used solely to distinguish between multiple elements with the same name and do not imply any hierarchy, ranking, execution sequence, or manufacturing order. A “first” element and a “second” element may both be present in the same component or in separate components. The presence of an element having a larger ordinal number does not necessarily indicate the presence of another element having a smaller ordinal number.

As used herein, unless otherwise indicated, the first feature “or” or “and/or” the second feature means that the first feature is present alone, the second feature is present alone, or both the first feature and the second feature are present. The so-called first feature “and” second feature mean that the first feature and the second feature are present together. The description of “including”, “comprising”, “having”, and “containing” means including, but not limited to here.

Also herein, terms such as “upper”, “lower”, “left”, “right”, “front”, “back”, or “between” are used solely to describe relative positions between elements and are to be construed as broadly encompassing translations, rotations, or mirror images. Further, in this document, the use of “a component on another component” or similar language does not necessarily mean that the component is in contact with the other component, unless specifically stated otherwise.

Moreover, unless specifically described or necessary for sequential steps to occur, the order of the above-described steps is not limited to that set forth above, and may be varied or rearranged as desired for design. In addition, the above-mentioned embodiments can be used in combination with each other or in combination with other embodiments based on the design and reliability considerations. That is to say, the technical features in different embodiments can be freely combined to form more embodiments.

The specific embodiments described above provide a further detailed explanation of the objectives, technical solutions, and beneficial effects of the present disclosure. It should be understood that these embodiments are merely illustrative of the present disclosure and are not intended to limit its scope. Any modifications, equivalent substitutions, or improvements made within the spirit and principles of the present disclosure shall fall within the scope of protection of the present disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An unmanned aerial vehicle (UAV) array-type airborne multi-component electric and magnetic field cooperative detection method, comprising:
S1, assembling and debugging a cooperative detection system;
S2, setting up system parameters of the detection system and flight parameters of a UAV array according to a field situation and user detection requirements;
S3, implementing the excitation of a primary electromagnetic pulse signal by the central primary field compensation technology according to a received control instruction;
S4, collecting a horizontal component electric field signal and a three-component magnetic field signal data; and
S5, preprocessing the acquired data of the horizontal component electric field signal and the three-component magnetic field signal, and obtaining underground space electrical information of a detection region by means of a joint inversion method of the electric and magnetic field data;
wherein the system parameters of the detection system comprise a transmitting current amplitude, a transmitting current shape, a transmitting current frequency of a current transmitter and a sampling rate of an electromagnetic data receiver; the flight parameters of the UAV array comprise a UAV array formation mode, a flight height, a flight speed and a flight route;
the obtaining underground space electrical information of a detection region by means of a joint inversion method of the electric and magnetic field data comprises: S51, setting an initial resistivity model and model parameters; S52, obtaining magnetic field response errors and electric field response errors by calculating errors between the magnetic field response and the electric field response of the initial resistivity model and the detected magnetic field response and electric field response by using the forward models of magnetic and electric field response; S53, constructing the Jacobian matrix of magnetic field and electric field data inversion by using the resistivity model, and calculating a model update quantity of magnetic field data inversion and a model update quantity of electric field data inversion by using the magnetic field response errors and the electric field response errors; S54, obtaining the updated resistivity model by adding the model update quantity and the model parameters; S55, judging whether a fitting error of the forward-modeling electric and magnetic field response data of the updated resistivity model is less than a set threshold value, and successively determining whether to perform iteration; and S56, ending the iteration when the fitting error is less than the set threshold value, and adding one to the number of iterations when the fitting error is greater than the set threshold value, and proceeding to the step S53; at this moment, the electric field inversion updated resistivity model is obtained by calculating the model parameters obtained from the magnetic field inversion in the last iteration, and the magnetic field inversion updated resistivity model is obtained by calculating the model parameters obtained from the electric field inversion in the last iteration, until the fitting error is less than the set threshold value to end the iteration.

2. An unmanned aerial vehicle (UAV) array-type airborne multi-component electric and magnetic field cooperative detection system for implementing the detection method as claimed in claim 1, comprising a UAV array, a transmitting unit, a plurality of receiving units and a ground support unit;
wherein the UAV array comprises a primary UAV and a plurality of follower UAVs;
the transmitting unit is mounted under the primary UAV and is configured to transmit a primary electromagnetic field pulse; the transmitting unit comprises a loop source transmitting device; the loop source transmitting device comprises a current transmitter, a transmitting coil and a compensation coil;
the plurality of receiving units are respectively mounted under the primary UAV and the follower UAVs, and are configured to collect electromagnetic data after a primary electromagnetic field pulse acts on a region to be measured, wherein the electromagnetic data comprises a horizontal component electric field signal and a three-component magnetic field signal; each receiving unit comprises a capacitive electric field sensor, a three-component coil magnetic field sensor, and an electromagnetic data receiver; and
the ground support unit is configured to control the collection of the horizontal component electric field signal and the three-component magnetic field signal, and perform electromagnetic data processing to obtain the underground space electrical information about the detection region.

3. The cooperative detection system according to claim 2, wherein the capacitive electric field sensor comprises:
an x-component electric field sensor configured to point a parallel direction of a survey line for measuring an x-component electric field; and
a y-component electric field sensor configured to point a perpendicular direction of the survey line for measuring a y-component electric field.

4. The cooperative detection system according to claim 2, wherein the capacitive electric field sensor uses a non-contact measurement principle to convert an unknown electric field to be measured into a voltage at both ends of a capacitor; the capacitive electric field sensor is arranged at front and rear ends of a connecting framework in the traveling direction of the survey line; the capacitive electric field sensor comprises an upper polar plate, a lower polar plate, a measurement circuit board and an insulating upright post;
the upper polar plate and the lower polar plate are arranged in parallel to form a parallel plate capacitor, and the material, the area and the thickness of the upper polar plate and the lower polar plate are all the same;
two input ends of the measurement circuit board are respectively connected to the upper polar plate and the lower polar plate; the measurement circuit board comprises a sampling capacitor;
the insulating upright post is configured to connect and fix the upper polar plate, the lower polar plate and the measurement circuit board;
the capacitive electric field sensor is placed in an electric field space, and charges generated on the surfaces of the upper polar plate and the lower polar plate will form a voltage at both ends of the sampling capacitor; and electric field data is obtained by measuring the voltage at both ends of the sampling capacitor.

5. The cooperative detection system according to claim 2, wherein the three-component coil magnetic field sensor comprises:
an x-component magnetic field sensor configured in a semi-circle shape, with the normal to the plane of the sensor being directed in an x-direction, for measuring an x-component magnetic field;
a y-component magnetic field sensor configured in a semi-circle shape, with the normal to the plane of the sensor being directed in a y-direction, for measuring a y-component magnetic field; and
a z-component magnetic field sensor configured in a circular shape, with the normal to the plane of the sensor being directed in a z-direction, for measuring a z-component magnetic field.

6. The cooperative detection system according to claim 5, wherein the transmitting coil, the compensation coil and the z-component magnetic field sensor are arranged in the same plane; and the radius ratio of the transmitting coil and the compensation coil is equal to the ratio of the turns of the transmitting coil and the compensation coil.

7. The cooperative detection system according to claim 2, wherein
the electromagnetic data receiver comprises:
a signal conditioning module configured to perform filtering and amplification on the received horizontal component electric field signal and three-component magnetic field signal;
a signal collection module comprising an analogue-to-digital conversion circuit and configured to perform data sampling on a signal conditioned by the signal conditioning module;
a storage module configured to store the multi-component electric field data and magnetic field data sampled by the signal collection module; and
a transmission module configured to transmit the collected multi-component electric field data and magnetic field data to the support unit;
the ground support unit comprises:
a control device configured to send a work control instruction by the cooperative detection system;
a monitoring device configured to monitor a system parameter state, multi-component electric field data, magnetic field data, and cooperative detection system location information of the cooperative detection system in real time; and
a data processing device configured for electromagnetic data processing to obtain the underground space electrical information about the detection region.

8. The cooperative detection system according to claim 2, further comprising:
a positioning device configured to position the UAV array in real-time and obtain longitude and latitude information about each UAV in the UAV array;
a radar altimeter configured to measure a flight height of the UAV array; and
a power supply device configured to supply power to the cooperative detection system.
